(19) United States
(12) Patent Application Publication
(10) Pub. No.: US 2021/0079876 A1
(43) Pub. Date: Mar. 18, 2021

(54) COMMON RAIL FUEL INJECTOR FOR DIESEL ENGINE

(71) Applicant: TIANJIN SHENGOUMEI ENGINE TECHNOLOGY CONSULTING CO. LTD, TIANJIN (CN)

(72) Inventor: Minglong TANG, TIANJIN (CN)

(21) Appl. No.: 16/968,189

(22) PCT Filed: Nov. 26, 2018
(86) PCT No.: PCT/CN2018/117368

§ 371 Date: Aug. 7, 2020

(30) Foreign Application Priority Data
Dec. 7, 2017 (CN) 201711281260.0
Sep. 15, 2018 (CN) 201811077686.9

(51) Int. Cl. F02M 47/02; F02M 51/06

(52) U.S. Cl. CPC F02M 47/027; F02B 3/06; F02M 51/0614

(57) ABSTRACT

The present invention provides a common rail fuel injector for a diesel engine. A valve seat of a fuel injector control valve adopts a T-shaped structure with a slot hole (2001c), and liquid passes through the slot hole of the valve seat of the control valve to control hydraulic pressure at a tail portion of a needle valve. A T-shaped pilot valve seat adopts a floating mounting structure: a large end of the T-shaped control valve seat faces downwards; a long column of the T-shaped pilot valve seat is slidably assembled in a central hole of a fuel injector body; a large end of the T-shaped control valve seat and the central hole of the fuel injector body are provided with a seal seat surface matched with each other.

### CROSS-REFERENCE TO RELATED APPLICATIONS

This application is a 371 of International Patent Application No. PCT/CN2018/117368 with a filing date of Nov. 26, 2018, designating the United States, now pending, and further claims priority to Chinese Patent Application No. 201711281260.0 with a filing date of Dec. 7, 2017, Chinese Patent Application No. 201811077686.9 with a filing date of Sep. 15, 2018. The content of the aforementioned applications, including any intervening amendments thereto, are incorporated herein by reference.

### TECHNICAL FIELD

The present invention belongs to the field of fuel injection of diesel engines, and particularly relates to the field of high pressure common rail electronic control fuel injection.

### BACKGROUND OF THE PRESENT INVENTION

An overall structure of a known high pressure common rail electronic control fuel injector is a pilot hydraulic valve, and a main structure can be divided into three portions, i.e. a needle valve portion, a pilot valve portion and an electromagnet portion. 1. The needle valve portion is also called fuel injector coupler and includes a needle valve body with a plurality of nozzles and a needle valve; the needle valve body is communicated with high pressure diesel fuel and is an execution component directly controlling the fuel injector; due to a large stressed area of the needle valve and high pressure of the diesel fuel as well as the limitation of the mounting space, the direct drive of the electromagnet cannot be used; 2, the pilot valve: the pilot valve is also called a control valve and is a high-speed electronic control hydraulic valve; an electromagnetic force of the electromagnet controls the needle valve to rise and fall after being hydraulically magnified by the high-speed hydraulic valve so as to control the fuel injection. At present, the pilot valve and the control mechanism mainly have two types of structures: (1) a structure with a control plunger represented by BOSCH; a valve body of the pilot valve is a ball body; a valve seat of the pilot valve is conical; a mounting position of the pilot valve is high and is far away from the needle valve body; a conical bottom of the pilot valve seat is provided with a fuel discharging orifice communicated with a control hydraulic cylinder; the control valve body is provided with a fuel inlet orifice; the control hydraulic cylinder is composed of a control plunger and a control valve body; the needle valve of the coupler is serially connected with the control plunger; a diameter of the control plunger is greater than the diameter of the needle valve of the coupler; a fuel return hole is arranged between the needle valve of the coupler and the control plunger; the needle valve of the coupler is provided with a preload spring; and the overall stress condition of the needle valve and the control plunger is changed by controlling the pressure of the hydraulic cylinder body through an electromagnetic valve. When the pilot valve is opened, the pressure in the hydraulic cylinder body is controlled to be reduced, and the needle valve and the control plunger are cooperated to raise the needle valve. When the electromagnetic valve is closed, the pressure of the hydraulic cylinder body is controlled to increase, and the needle valve and the control plunger are cooperated to close the needle valve. (2) A structure without a control plunger represented by Delphi: the pilot valve is mounted close to the needle valve, and the pilot valve directly controls the liquid pressure at the tail portion of the needle valve to realize the rise and fall of the needle valve. 3 A drive portion: the drive portion generates a driving force of the pilot valve, and the existing structure includes an electromagnetic type, a piezoelectric type and a magnetostriction type. A spring presses a valve body of the pilot valve against the valve seat to close the pilot valve, and the electromagnetic driving force overcomes a spring force to open the pilot valve.

In the known high pressure common rail electronic control fuel injector, in order to guarantee the initial seal of the needle valve, a needle valve spring is mounted on the needle valve, one end of the needle valve spring abuts on a spring seat of the needle valve, and one end abuts on a spring seat of the fuel injector body. With respect to the structure without the control plunger represented by Delphi, the pilot valve controls the pressure at the tail portion of the needle valve to control the rise and fall of the needle valve. A clearance space for mounting the needle valve spring is connected with the hydraulic cylinder at the tail portion of the needle valve, which increases the volume of the hydraulic cylinder, and due to the great pressure change of the control hydraulic cylinder, the elasticity of the liquid reduces a response speed of the needle valve.

For the structure with the control plunger represented by BOSCH, since the tail portion of the needle valve is communicated with the fuel return hole, the needle valve spring cannot cause the reduction of the response speed. However, the mass of the control plunger is large, and a total mass of the control plunger and the needle valve is a movement mass of the valve body, so that under the same response speed, a higher driving force is required, and at the same time, when the needle valve is closed, the impact force of the needle valve and the needle valve seat is large.

In the fuel injector represented by BOSCH, a valve ball ejector rod of the pilot valve passes through a central hole of the electromagnet, and the valve ball ejector rod and an armature are concentrically mounted in a sliding fitting manner. A diameter of an upper portion (close to the direction of a coil) of the ejector rod is greater than the diameter of a central hole of the armature of the electromagnet. The spring is mounted at the tail portion of the ejector rod. The downward movement of the ejector rod relative to the armature can be transferred to the armature, while the upward movement of the ejector rod relative to the armature is not transferred to the armature. The upward movement of the armature relative to the ejector rod can be transferred to the ejector rod, while the downward movement of the armature relative to the ejector rod cannot be transferred to the ejector rod. When the ejector rod moves downwards, and the valve ball contacts the ball seat, the speed of the ejector rod is reduced rapidly. The ejector moves upwards relative to the armature, the armature continues to move downwards, and the valve seat and the ball seat do not suffer the impact force of the armature. Similarly, when the armature moves upwards to contact an upper half portion of the electromagnet, the armature is not subjected to the impact force of the ejector rod. However, in order to realize the function, the armature is in clearance sliding fit with the ejector rod, and at the same time, in order to guarantee the effective guide, the ejector rod must have a large diameter and height, so that the mass of the ejector rod is large, and consequently the diameter of the armature is increased, thereby finally greatly neutralizing the reduced impact force of the structure. At the same time, due to the presence of a buffer lift of the armature, the response speed is also reduced.

### SUMMARY OF PRESENT INVENTION

A technical problem to be solved is to solve the problem affecting the response speed of the existing electronic control fuel injector and to solve the problem that a needle valve and a control valve are high in impact force.

A specific technical solution is as follows: a valve seat of a fuel injector control valve adopts a T-shaped columnar structure with a slot hole; liquid passes through the slot hole of a pilot valve seat to control hydraulic pressure at a tail portion of the needle valve to control the rise and fall of the needle valve; and a control plunger of the fuel injector represented by BOSCH is canceled. The T-shaped pilot valve seat adopts a floating mounting structure: a large end of the T-shaped control valve seat faces downwards; a long column of the T-shaped pilot valve seat is slidably assembled in a central hole of a fuel injector body; the large end of the T-shaped control valve seat and the central hole of the fuel injector body are provided with a seal seat surface matched with each other, and the hydraulic pressure at the lower end of the T-shaped control valve seat enables the seal surface of the T-shaped control valve seat to press the seal surface of the fuel injector body. No needle valve spring is mounted on the tail portion of the needle valve. When an engine is stopped or just started, when the system pressure of the T-shaped control valve is relatively low, and when the pressure on the lower end surface of the T-shaped control valve seat is smaller than a spring force of the control valve, the spring force of the control valve drives the T-shaped control valve seat, so that the T-shaped control valve seat presses the tail portion of the needle valve to close the needle valve, and the spring of the control valve also plays a role of a preload spring of the needle valve.

A main fuel inlet passage is provided with a pressure adjusting mechanism, so that when the needle valve is opened, and the pressure of the diesel fuel entering the lower portion of the needle valve is reduced; and when the control valve is closed, the pressure at the tail portion of the needle valve is higher than that at the front end of the needle valve, and the needle valve is closed by the pressure difference.

An optimized hydraulic pressure adjusting mechanism of the main fuel passage is a structure in which a spring pressure adjusting valve is serially connected with an orifice mat, and successively includes a pressure adjusting valve seat, a pressure adjusting valve core, a pressure adjusting spring and the orifice mat from top to bottom.

A simplified hydraulic pressure adjusting mechanism of the main fuel passage is a pure orifice structure without a spring pressure adjusting valve.

The optimized hydraulic pressure adjusting mechanism of the main fuel passage is arranged on a fuel injector coupler body, and a conical orifice core is mounted in a conical hole on a fuel inlet passage of the fuel injector coupler body.

An optimized control fuel inlet is provided with a fuel inlet metering hole between the main fuel passage of the fuel injector body and the central hole of the fuel injector body.

The optimized control valve is a conical seat ball valve structure. A drive mechanism is an EI electromagnet structure. An electromagnet armature is fixed together with an armature guide column. The armature guide column is downwardly mounted in a guide sleeve, and the guide column pushes against a ball seat; and the upper end surface of the armature pushes against a control valve spring. An armature buffer structure represented by BOSCH is canceled, so that the mass of a movement system is reduced.

The optimized electromagnet armature is a grooved liquid discharging electromagnet armature. The periphery of the guide column is provided with longitudinal grooves serving as fuel discharging passages, thereby reducing the movement mass and reducing the magnetic flux leakage.

The optimized electromagnet armature is a liquid discharging armature with an inner hole. The guide column is provided with a central through hole serving as a fuel discharging passage. The end portion of the guide column is provided with a liquid guide groove, thereby reducing the movement mass and reducing the magnetic flux leakage. The diesel fuel discharged from the control valve is used to cool the electromagnet.

The guide sleeve of the electromagnet armature guide column is concentric with the central hole of the fuel injector. The guide sleeve projects upwards for a length of 2 to 5 mm, thereby increasing an air gap between the lower surface of the armature and the fuel injector body, and reducing the magnetic flux leakage.

The simplified electromagnet guide sleeve does not project upwards. By increasing the length of the guiding column, a distance between a large disc of the electromagnet armature and the end surface of the guide sleeve is increased to 2 to 5 mm, thereby increasing the air gap between the lower surface of the armature and the fuel injector body, and reducing the magnetic flux leakage.

An optimized electromagnet iron core is a multilayer (2 to 4 layers) two-ring structure with a central hole.

The present invention has the beneficial effects: the hydraulic pressure at the tail portion of the needle valve is controlled by the T-shaped control valve with the slot hole to control the rise and fall of the needle valve, a control valve column is canceled, and the total mass of the needle valve movement body is reduced, so that the response speed can be improved, and the impact force of the needle valve can be reduced.

The T-shaped control valve seat adopts the floating mounting structure; the liquid pressure at the lower end surface of the T-shaped control valve makes the seal surface of the T-shaped control valve seat press the seal surface of the fuel injector body, thereby reducing the mounting procedures. Meanwhile, when the T-shaped pilot valve seat contacts the valve ball, the length of the T-shaped column of the T-shaped pilot valve seat is shortened, so that the impact force of the control valve ball can be partially absorbed.

By mounting the T-shaped control valve seat in a floating manner, the spring of the control valve also plays a role of a preload spring of the needle valve, and the tail portion of the needle valve controls the volume of the hydraulic liquid, thereby increasing the response speed.

The armature and the guide column are of an integrated structure, and the guide column faces downwards and also plays a role of a ball valve ejector rod, thereby reducing the mass of the movement system, and reducing the diameter of the armature.

The guide sleeve of the electromagnet armature guide column projects upwards for a length of 2 to 5 mm to increase the air gap between the lower surface of the armature and the fuel injector body, thereby reducing the magnetic flux leakage, and reducing the diameter of the armature.

### DESCRIPTION OF THE DRAWINGS

The present invention is further described below in combination with the accompanying drawings.

FIG. 1 is a structural schematic diagram of a fuel injector with a control plunger;

FIG. 2 is a structural schematic diagram of a fuel injector without a control plunger;

FIG. 3 is a structural diagram of a fuel injector without a needle valve preload spring;

FIG. 4 is a local diagram of a control valve of a fuel injector without a needle valve preload spring;

FIG. 5 is a local diagram of a pressure adjusting portion of a fuel injector without a needle valve preload spring;

FIG. 6 is a structural diagram of a solution II of an electromagnet iron core;

FIG. 7 is a three-dimensional diagram of a grooved liquid discharging armature;

FIG. 8 is a three-dimensional diagram of a liquid discharging armature with an inner hole; and

FIG. 9 is a structural diagram of a solution II for pressure adjustment of a main fuel passage.

### DETAILED DESCRIPTION OF PREFERRED EMBODIMENTS

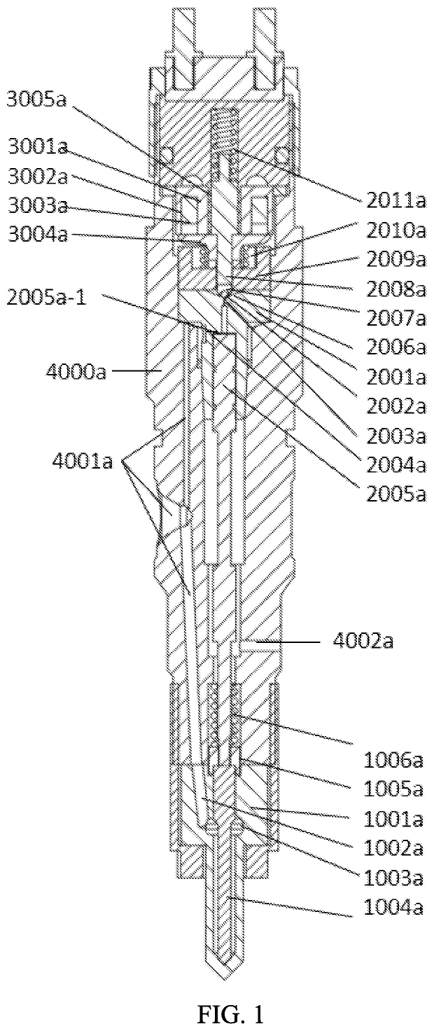

FIG. 1 is a structural diagram of a known fuel injector with a control plunger. In FIG. 1, a coupler seat (1001a) with a central hole and a conical base is concentrically in sliding fit with a valve needle (1004a) with a conical tip. A plurality of fuel injection holes are distributed on the conical base of the coupler seat (1001a). A fuel passage (1002a) on the coupler seat (1001a) is connected with high pressure fuel through a fuel passage (4001a) on a fuel injector body (4000a). The fuel passage (1002a) on the coupler seat (1001a) enters the valve needle (1004a) and an annular fuel passage at a lower portion of the coupler seat (1001a) through an annular groove (1003a). When the valve needle (1004a) is lowered and the conical base of the coupler seat contacts the conical tip of the valve needle (1004a), the fuel injector is closed. When the valve needle (1004a) rises and the conical base of the coupler seat is separated from the conical tip of the valve needle (1004a), the fuel injector is opened for fuel injection.

A spring seat (1005a) is mounted at the tail portion of the needle valve. A needle valve spring (1006a) is mounted on a spring seat (1005a) and a spring seat of the fuel injector body (4000a), and the needle valve spring (1006a) enables the valve needle (1004a) to generate a downward force, thereby ensuring that the system closes the needle valve when the pressure of the diesel fuel in a high pressure fuel passage is relatively low.

A control plunger (2005a) is slidably mounted in a control valve central hole of a control valve seat (2001a). A control fuel cylinder (2005a-1) is arranged between the tail portion of the control plunger (2005a) and a central hole of the control valve seat (2001a). A control fuel inlet metering hole (2004a) is communicated with the control fuel cylinder and the high pressure fuel passage (4001a). A fuel discharging metering hole (2003a) on the control valve seat (2001a) makes the control fuel cylinder communicated with the conical seat of the control valve seat (2001a). A valve ball (2002a) is mounted between the control valve conical seat (2006a) and a valve ball seat (2007a). The fuel injector body (4000a) is provided with a fuel return hole (4002a). The fuel return hole is communicated with a lower section of the control plunger (2005a), the top of the needle valve and a control valve fuel outlet. A large diameter section of an upper portion of an electromagnetic valve guide top column (2008a) is slidably mounted in an electromagnet guide hole (3005a). A small diameter section of a lower portion of the electromagnetic valve guide top column is slidably mounted in a central hole of an armature (3004a). A middle step of the electromagnetic valve guide top column (2008a) presses an upper end surface of the armature (3004a). An electromagnetic valve spring (2011a) is mounted on the top of the electromagnetic valve guide top column. An armature spring (2010a) is mounted at the lower portion of the armature (3004a). A control valve seat fixed screw (2009a) presses a control valve seat (2001a).

The electromagnet is an EI electromagnet. The electromagnet is composed of an iron core of a two-ring structure (3001a and 3002a) and a coil (3003a).

In FIG. 1, after the electromagnet coil (3003a) is energized, the armature (3004a) moves upwards to drive the electromagnetic valve guide top column (2008a) to move upwards; the valve ball (2002a) is opened upwards; the control fuel is discharged from the fuel discharging metering hole (2003a); the top pressure of the control plunger (2005a) is reduced; an upward force applied to the needle valve (1004a) is greater than a sum of the pressure of the spring (1006a) and the top pressure of the control plunger (2005a); the needle valve (1004a) and the control plunger (2005a) move upwards; the needle valve (1004a) is opened; and the fuel injector begins the fuel injection.

After the electromagnet coil (3003a) in FIG. 1 is de-energized, the electromagnetic valve guide top column moves downwards under the effect of an electromagnetic valve spring (2011a) to push the armature (3004a), the valve ball seat (2007a) and the valve ball (2002a) to move towards the control valve seat (2001a); the valve ball (2002a) is closed; the fuel discharging metering hole (2003a) stops the fuel discharging; the top pressure of the control plunger (2005a) increases; an upward force applied to the needle valve (1004a) is less than a sum of the pressure of the spring (1006a) and the top pressure of the control plunger (2005a); the needle valve (1004a) and the control plunger (2005a) move downwards; the needle valve (1004a) is closed; and the fuel injector stops the fuel injection.

In FIG. 1, the control plunger (2005a) and the needle valve (1004a) move synchronously, so that the impact force is large when the needle valve (1004a) is closed.

In FIG. 1, the electromagnetic valve guide top column moves downwards under the effect of the electromagnetic valve spring (2011a) to push the armature (3004a), the valve ball seat (2007a) and the valve ball (2002a) to move towards the control valve seat (2001a). When the valve ball (2002a) contacts the control valve conical seat (2006a), the electromagnetic valve guide top column (2008a), the valve ball seat (2007a) and the valve ball (2002a) are stopped quickly; the armature (3004a) continues to move forwards; and the armature (3004a) is separated from the guide top column (2008a), so that the impact force of the armature (3004a) acting on the valve ball (2002a) is reduced.

In FIG. 1, the electromagnetic valve guide top column moves upwards under the effect of the armature (3004a), and when the armature (3004a) contacts iron cores (3001a, 3002a), the armature (3004a) is stopped quickly. The guide top column continues to move forwards under the effect of the armature (3004a), and the armature (3004a) is separated from the guide top column (2008a), so that the impact force of the armature (3004a) acting on the iron cores (3001a, 3002a) is reduced.

In FIG. 1, the electromagnetic valve guide top column is in sliding fit with the armature (3004a) and is divided into a guide section with a large diameter and a top rod section with a small diameter. An overall mass of the electromagnetic valve guide top column is large. Although the force of the armature (3004a) applied to the valve ball (2002a) is reduced when the valve ball (2002a) is closed, the impact force between the valve ball (2002a) and the control valve conical seat (2006a) is still relatively large.

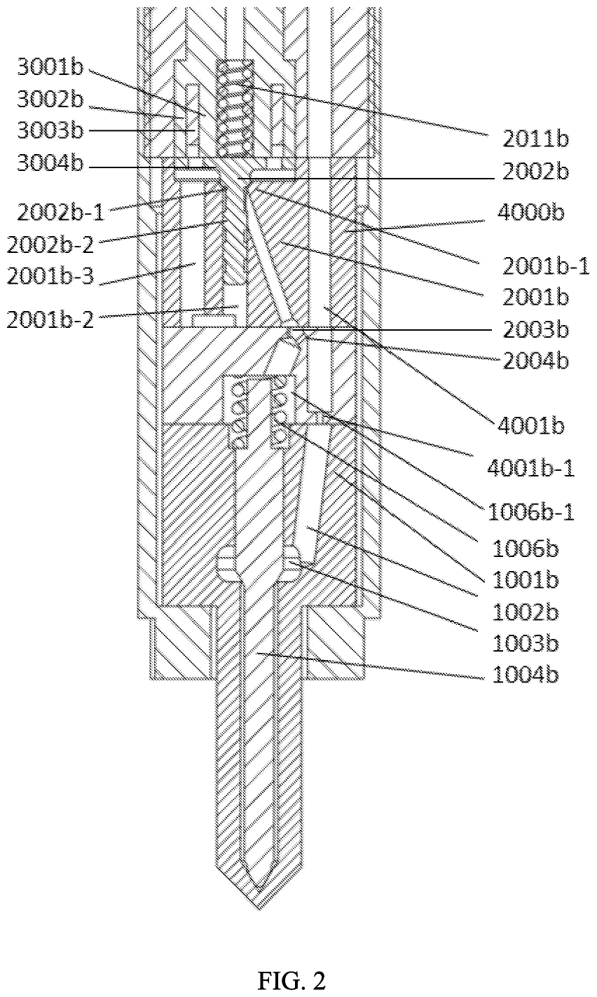

FIG. 2 is a structural schematic diagram of a known fuel injector without a control plunger. In FIG. 2, a coupler seat (1001b) with a central hole and a conical base is concentrically in sliding fit with a valve needle (1004b) with a conical tip. A plurality of fuel injection holes are distributed on the conical base of the coupler seat (1001b). A fuel passage (1002b) on the coupler seat (1001b) is connected with high pressure fuel through a main fuel passage (4001b) on a fuel injector body (4000b). The main fuel passage is provided with an orifice (4001b-1). The fuel passage (1002b) on the coupler seat (1001b) enters the valve needle (1004b) and an annular fuel passage at the lower portion of the coupler seat (1001b) through an annular groove (1003b). When the valve needle (1004b) is lowered and the conical base of the coupler seat contacts the conical tip of the valve needle (1004b), the fuel injector is closed. When the valve needle (1004b) rises and the conical base of the coupler seat is separated from the conical tip of the valve needle (1004b), the fuel injector is opened for fuel injection.

FIG. 2 shows a fuel injector without a control plunger. A needle valve spring (1006b) is mounted at the tail portion of the needle valve; the top of the needle valve spring (1004b) and a mounting space of the spring (1006b) are provided with a control hydraulic cylinder (1006b-1); and the needle valve spring (1006b) makes the valve needle (1004b) generate a downward force, thereby ensuring that the system closes the needle valve when the pressure of the diesel fuel in the high pressure fuel passage is relatively low, and also providing a closing force to the needle valve.

In FIG. 2, a control valve of the fuel injector without the control plunger adopts a structure with a balance mechanism. A valve core (2002b) is combined with an armature (3004b). A control valve spring (2011b) is mounted on the upper surface of the armature (3004b). A valve core is provided with a conical seal surface (2002b-1) and a sliding seal section (2002b-2). The sliding seal section (2002b-2) also plays a guide role. The sliding seal section (2002b-2) is mounted in a control valve guide hole (2001b-2) of the valve seat (2001b). The conical seal surface (2002b-1) is in sealing fit with a conical surface (2001b-1) of the valve seat (2001b). The valve seat guide hole (2001b-2) is communicated with a pressure relief hole (2001b-3). The liquid pressure applied to the valve core (2002b) is almost balanced. Therefore, the spring force of the control valve spring (2010b) mounted at the armature (3004b) is relatively small.

In FIG. 2, an electromagnet of the fuel injector without the control plunger is an EI electromagnet. The electromagnet is composed of an iron core of a two-ring structure (3001b, 3002b) and a coil (3003b).

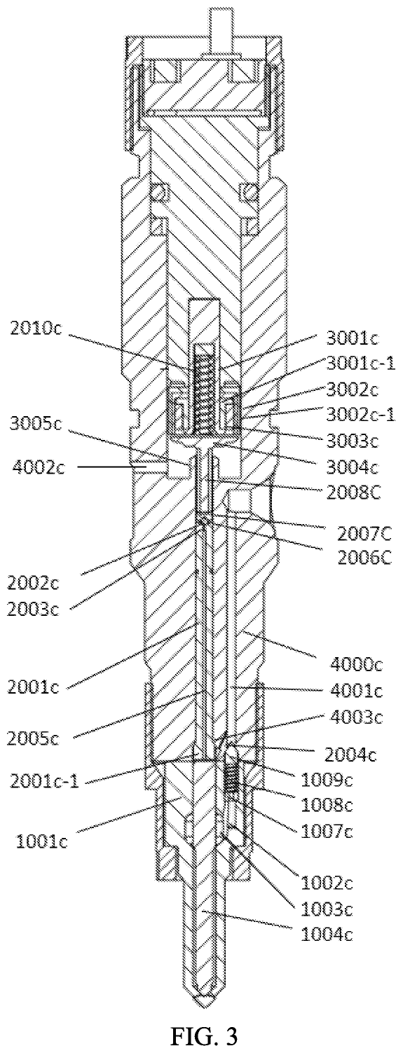

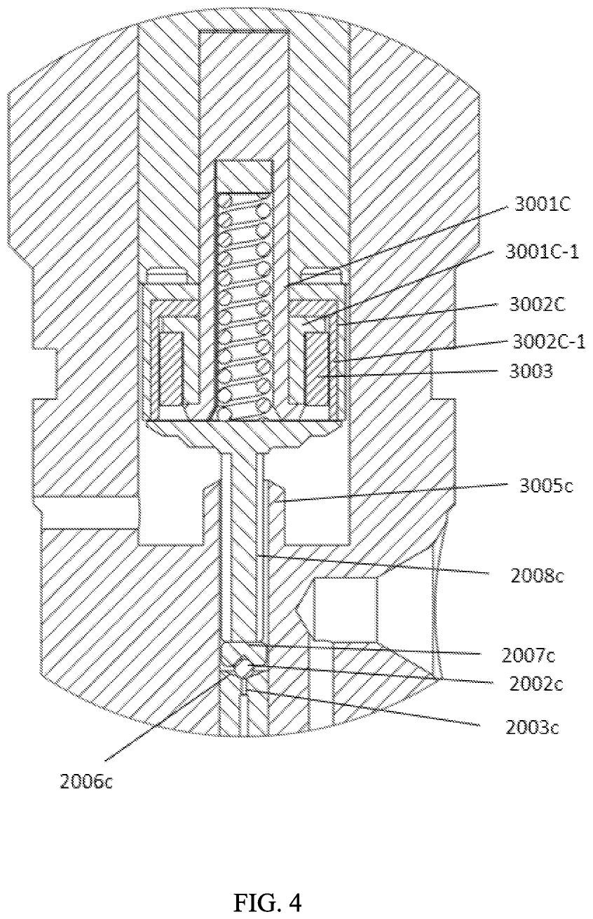

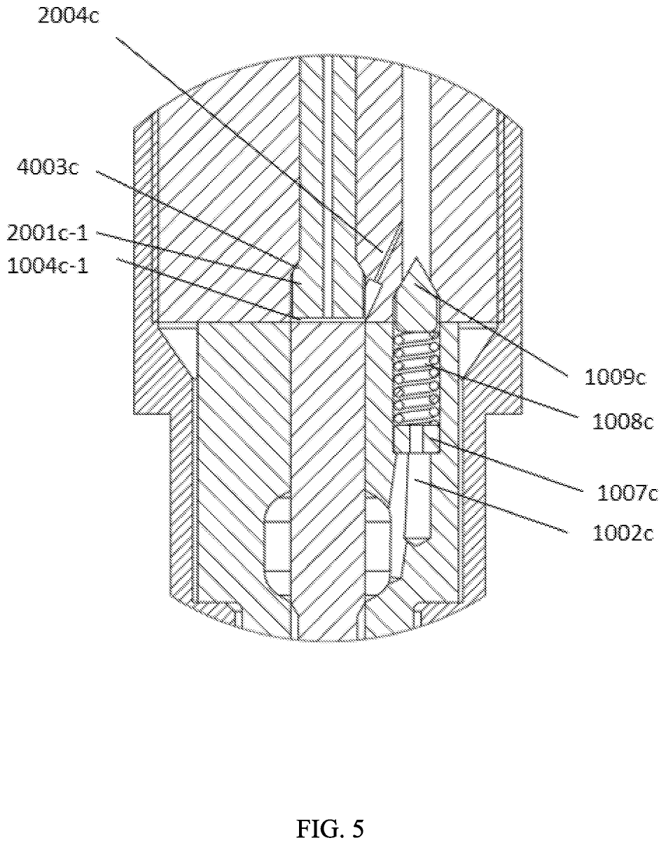

FIGS. 3-5 show a structure of the fuel injector without a needle valve preload spring of the present invention. In FIGS. 3-5, a coupler seat (1001c) with a central hole and a conical base and a valve needle (1004c) with a conical tip are concentrically mounted in a sliding fitting manner. A plurality of fuel injection holes are distributed on the conical base of the coupler seat (1001c). A fuel passage (1002c) on the coupler seat (1001c) is connected with high pressure fuel through gaps among an orifice mat (1007c) on the fuel injector body (4000c), a pressure adjusting spring (1008c), a pressure adjusting valve core (1009c) and a pressure adjusting valve seat and a fuel passage (4001c). The fuel passage (1002c) on the coupler seat (1001c) enters the valve needle (1004c) and an annular fuel passage at the lower portion of the coupler seat (1001c) through an annular groove (1003c). When the valve needle (1004c) is lowered and the conical base of the coupler seat contacts the conical tip of the valve needle (1004c), the fuel injector is closed. When the valve needle (1004c) rises, and the conical base of the coupler seat is separated from the conical tip of the valve needle (1004c), the fuel injector is opened for fuel injection.

According to the fuel injector without the needle valve spring in FIGS. 3-5, the valve seat (2001c) of the fuel injector control valve adopts a slot-hole T-shaped columnar structure. A valve seat of the control valve includes a conical valve seat (2006c), a central hole long column body, and a lower large-diameter seal head (2001c-1). The conical valve seat is provided with a fuel outlet orifice (2003c) communicated with the central slot hole (2005c). The central slot hole (2005c) is communicated with a tail hydraulic cylinder (1004c-1) of the needle valve (1004c). The valve seat of the T-shaped control valve adopts a floating mounting structure. A valve seat long column of the T-shaped control valve is slidably assembled in the central hole of the fuel injector body (4000c). The liquid pressure on the end surface of the large-diameter seal head (2001c-1) of the T-shaped control valve seat makes the seal seat of the T-shaped control valve seat press a seal seat (4003c) of the fuel injector body. The control fuel successively passes through a main fuel passage (4001c), a fuel inlet orifice (2004c) and a gap between the control valve seat and the central hole to enter the control hydraulic cylinder (1004c-1). The control fuel successively passes through the central slot hole (2005c), a fuel outlet orifice (2003c), the control valve composed of the valve seat (2006c) and the valve ball (2002c), and a fuel return hole (4002c) to be discharged from the hydraulic cylinder (1004c-1).

In FIGS. 3-5, the valve ball (2002c) is mounted on a conical valve seat (2006c). The ball seat (2007c) is mounted on the valve ball (2002c). The guide column (2008c) pushes against the ball seat (2007c). The guide column (2008c) is fixed together with the armature (3004c). A guide sleeve (3005c) projects upwards. The guide column (2008c) is mounted in the guide sleeve (3005c). A control valve spring (2010c) is mounted on the upper portion of the armature (3004c). An outer iron core of the electromagnet is formed by stacking two layers of L-shaped rings (3002c, 3002c-1). An inner iron core is composed of a fixed column (3001c) with a positioning step and an L-shaped compression ring (3001c-1). The inner iron core fixed column (3001c) is fixed on an iron core mounting body. The step of the inner iron core fixed column (3001c) is pressed against the compression ring (3001c-1). The compression ring (3001c-1) is pressed against the two layers of L-shaped rings (3002c, 3002c-1). The coil (3003c) is mounted in an annular space between the outer and inner iron cores.

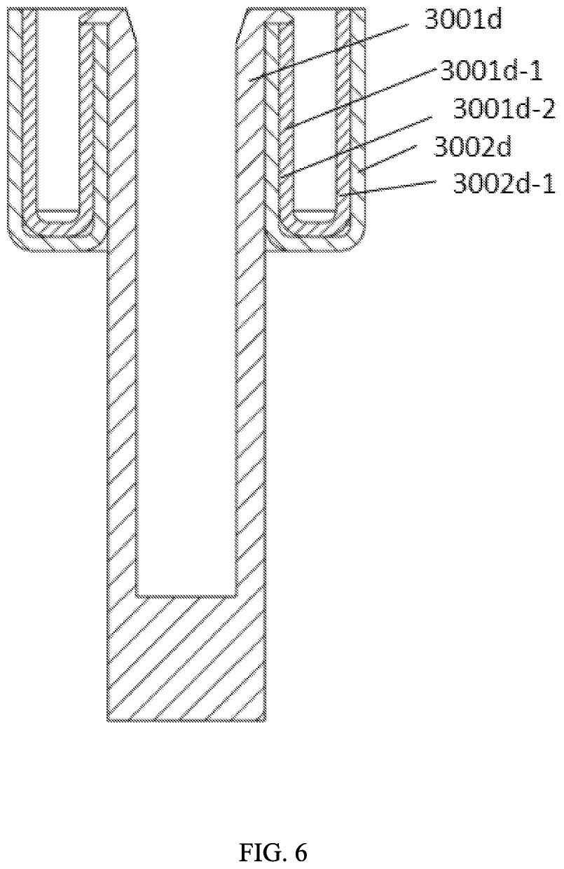

FIG. 6 shows a second embodiment of an electromagnet iron core. An inner and outer iron cores (3001d-1, 3001d-2, 3002d, 3002d-1) are formed by stacking two layers of U-shaped rings. The U-shaped rings are fixed by an iron core fixed column (3001d) with a step.

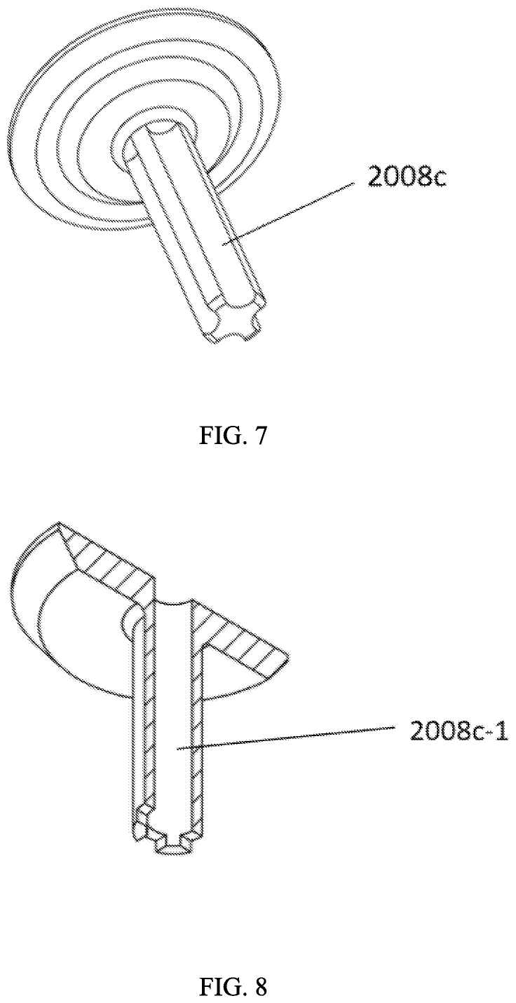

FIG. 7 shows a shape of a grooved liquid discharging armature. In FIG. 7, a large-disc-shaped armature is fixed together with a guide column. Liquid discharging grooves are distributed on the periphery of the guide column. The armature is suitable for the fuel injector with an external fuel return port higher than the electromagnet.

FIG. 8 shows a shape of a liquid discharging armature with an inner hole. In FIG. 8, the large-disc-shaped armature is fixed together with the guide column (2008c-1). The center of the guide column is provided with a through hole. The end portion of the guide column is provided with a liquid guide groove. High pressure liquid discharged from the control valve directly flows to the electromagnet to cool the electromagnet. The armature is particularly suitable for the fuel injector with an inner fuel return port lower than the electromagnet and also suitable for the fuel injector with the fuel return port higher than the electromagnet.

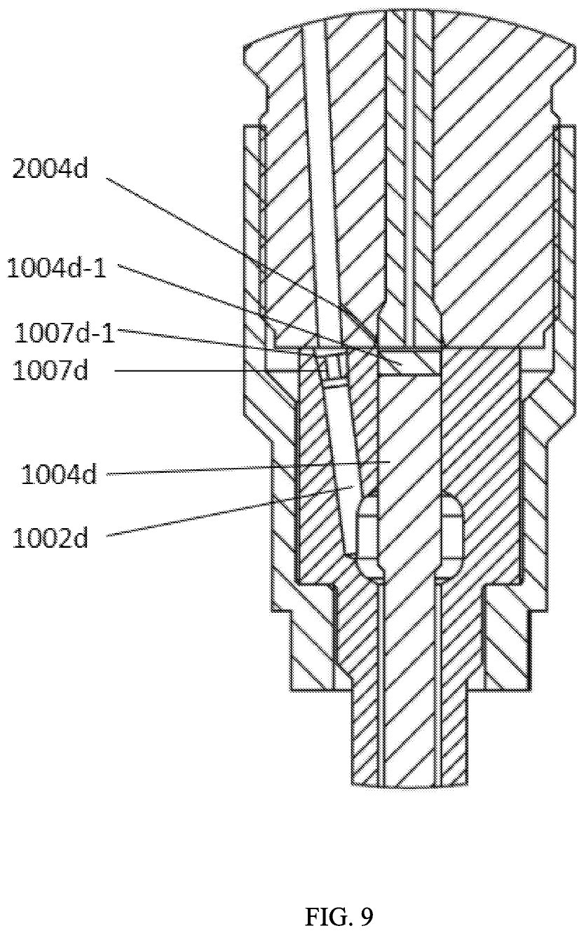

FIG. 9 shows a structure of a simplified main fuel passage pressure adjusting mechanism. In FIG. 9, an upper section of an oblique fuel passage (1002d) of the coupler is provided with a conical fuel hole (1007d-1). A conical orifice core (1007d) is mounted in the conical fuel hole (1007d-1). In FIG. 9, the length of the valve needle (1004d) is reduced, and a stroke adjusting mat (1004d-1) is mounted in the hole of the fuel injector coupler. The fuel inlet metering hole (2004d) is arranged on an out-flared slope of an opening of the central hole of the fuel injector body.

The fuel inlet and the fuel return port of the fuel injector body of the present embodiment are built-in. The solutions of the present invention are apparently suitable for the fuel injector with the external fuel inlet and external fuel outlet, which is not described in detail herein.

We claim:

1. A common rail fuel injector for a diesel engine, wherein a valve seat of a fuel injector control valve adopts a slot-hole T-shaped columnar structure (2001C); liquid passes through a slot hole of the valve seat of the control valve to control hydraulic pressure at a tail portion of a needle valve; a T-shaped pilot valve seat adopts a floating mounting structure: a large end of the T-shaped control valve seat faces downwards, and a long column of the T-shaped pilot valve seat is slidably assembled in the central hole of the fuel injector body; the large end of the T-shaped control valve seat and the central hole of the fuel injector body are provided with a seal seat surface matched with each other; the hydraulic pressure at the lower end of the T-shaped control valve seat enables the seal surface of the T-shaped control valve seat to press the seal surface of the fuel injector body; no needle valve spring is mounted on the tail portion of the needle valve; when an engine is stopped or just started, when the system pressure of the T-shaped control valve is relatively low, and when the pressure on the lower end surface of the T-shaped control valve seat is smaller than a spring force of the control valve, the spring force of the control valve drives the T-shaped control valve seat, so that the T-shaped control valve seat presses the tail portion of the needle valve to close the needle valve, and the spring of the control valve also plays a role of a needle valve preload spring; a pressure adjusting mechanism is arranged on a main fuel inlet passage, so that when the needle valve is opened, the pressure of the diesel fuel entering the lower portion of the needle valve is reduced; and when the control valve is closed, the pressure at the tail portion of the needle valve is higher than the pressure at the front end of the needle valve, and the needle valve is closed by the pressure difference.

2. The common rail fuel injector for the diesel engine according to claim 1, wherein the hydraulic pressure adjusting mechanism of the main fuel passage is a structure in which a spring pressure adjusting valve is serially connected with an orifice mat and successively comprises a pressure adjusting valve seat, a pressure adjusting valve core (1009c), a pressure adjusting spring (1008c) and the orifice mat (1007c) from top to bottom.

3. The common rail fuel injector for the diesel engine according to claim 1, wherein the hydraulic pressure adjusting mechanism of the main fuel passage is a conical orifice core (1007d), and adopts a structure that an upper section of a coupler body oblique fuel passage (1002d) is provided with a conical fuel hole (1007d-1), and the conical orifice core (1007d) is mounted in the conical fuel hole (1007d-1).

4. The common rail fuel injector for the diesel engine according to claim 1, wherein a valve seat in the hydraulic adjusting mechanism of the main fuel passage is arranged on a fuel injector body, and the pressure adjusting valve core (1009c) is mounted on the adjusting valve seat of the fuel injector body; and the pressure adjusting spring (1008c) and the orifice mat (1007) are mounted on the main fuel passage of the coupler.

5. The common rail fuel injector for the diesel engine according to claim 1, wherein an electromagnet armature (3004c) is fixed together with an armature guide column (2008c); the armature guide column is downwardly mounted in a guide sleeve (3005c);
and the guide column pushes against a ball valve seat (2007c).

6. The common rail fuel injector for the diesel engine according to claim 1, wherein an optimized electromagnet armature is a grooved liquid discharging electromagnet armature, and the periphery of the guide column (2008c) is provided with longitudinal grooves serving as fuel discharging passages.

7. The common rail fuel injector for the diesel engine according to claim 1, wherein an optimized electromagnet armature is a liquid discharging armature with an inner hole; the armature is fixed together with the guide column (2008c-1); the center of the guide column is provided with a through hole; and the end portion of the guide column is provided with a liquid guide groove.

8. The common rail fuel injector for the diesel engine according to claim 1, wherein the guide sleeve of the guide column projects upwards for a section of 2 to 5 mm, thereby increasing an air gap between the lower surface of the armature and the fuel injector body.
